(19) United States
(12) Patent Application Publication
(10) Pub. No.: US 2019/0234108 A1
(43) Pub. Date: Aug. 1, 2019

(54) DOOR LOCK

(71) Applicant: Zhongshan Huibao Lock Manufacturing Co., Ltd., Zhongshan (CN)

(72) Inventor: Weixuan LI, Zhongshan (CN)

(21) Appl. No.: 16/145,228

(22) Filed: Sep. 28, 2018

(30) Foreign Application Priority Data
Jan. 9, 2018 (CN) 201810019316.3
Jan. 9, 2018 (CN) 201820049010.8
Jul. 11, 2018 (CN) 201810757775.1
Jul. 11, 2018 (CN) 201821100770.3

(51) Int. Cl. E05B 13/10; E05B 17/20; E05B 15/00

(52) U.S. Cl. CPC E05B 13/105; E05B 15/0033; E05B 17/2007

(57) ABSTRACT

A door lock including: an outer handle assembly; an inner handle assembly; a clutch disposed between the outer handle assembly and the inner handle assembly; and a safety mechanism disposed on the clutch. The inner handle assembly includes an inner baffle, an inner shielding cover, a hollow cylindrical passage, a transmission rack, and an inner handle. The clutch includes a transmission square tube and a sub-clutch part connected to the transmission square tube. The safety mechanism includes a brake bar and a driving unit which are disposed in the transmission square tube. The hollow cylindrical passage includes a side wall and a plurality of axial guide grooves disposed on the side wall. The driving unit includes a sleeve tube and an actuator disposed in the sleeve tube. The actuator includes a sliding positioning tongue disposed on the circumferential surface of the actuator.

### CROSS-REFERENCE TO RELAYED APPLICATIONS

Pursuant to 35 U.S.C. § 119 and the Paris Convention Treaty, this application claims foreign priority to Chinese Patent Application No. 201810019316.3 filed Jan. 9, 2018, Chinese Patent Application No. 201820049010.8 filed Jan. 9, 2018, Chinese Patent Application No. 201810757775.1 filed Jul. 11, 2018, and Chinese Patent Application No. 201821100770.3 filed Jul. 11, 2018. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

This disclosure relates to a door lock.

Conventionally, a door lock includes an actuator, an inclined chute, a locating slot and a sliding positioning tongue. To lock the door lock, the actuator is pressed by a user, and the sliding positioning tongue starts sliding in the inclined chute and finally falls into the locating slot to achieve the locking. In the process, the actuator rotates in a certain angle, which increases the difficulty for the sliding positioning tongue to be clamped in the locating slot.

### SUMMARY

Disclosed is a door lock that is easy to lock and unlock.

Disclosed is a door lock comprising: an outer handle assembly; an inner handle assembly; a clutch disposed between the outer handle assembly and the inner handle assembly; and a safety mechanism disposed on the clutch. The inner handle assembly comprises an inner baffle, an inner shielding cover, a hollow cylindrical passage, a transmission rack, and an inner handle; the clutch comprises a transmission square tube and a sub-clutch part connected to the transmission square tube; the safety mechanism comprises a brake bar and a driving unit which are disposed in the transmission square tube; the hollow cylindrical passage comprises a side wall and a plurality of axial guide grooves disposed on the side wall; the driving unit comprises a sleeve tube and an actuator disposed in the sleeve tube; a tube wall of the sleeve tube is provided with an inclined chute deviating from an axial direction of the sleeve tube; one end of the sleeve tube is provided with a tube hole corresponding to the brake bar; one terminal end of the inclined chute is provided with a locating slot; and the actuator comprises a sliding positioning tongue disposed on a circumferential surface of the actuator to drag the actuator to slide along the plurality of axial guide grooves and push the sleeve tube to rotate and be clamped in the locating slot of the inclined chute.

The door lock can further comprise a lock piece disposed between the sub-clutch part and the outer handle assembly; the lock piece can comprise a through hole and a lug, and the brake bar can be inserted in the through hole of the lock piece; the outer handle assembly can comprise a locking groove corresponding to the lug.

The inner baffle can be embedded in the inner shielding cover; the hollow cylindrical passage can be in running fit with the inner baffle and the inner shielding cover; and the transmission rack can be disposed at one side of the hollow cylindrical passage, and the inner handle can be disposed at the other side of the hollow cylindrical passage.

The inner handle can comprise a base and a hand grip; one end of the base can be provided with a connection hole, and the other end of the base can be provided with a guide hole; the hollow cylindrical passage can be inserted into the connection hole of the base, and the lock piece can be in sliding fit with the guide hole of the base.

Advantages of the door lock as described in the disclosure are summarized as follows: the actuator of the door lock can only move longitudinally along the axial guide grooves of the hollow cylindrical passage, and the tube sleeve rotates in the hollow cylindrical passage and finally is clamped in the locating slot, achieving the locking of the door lock. The locking is efficient and safe.

### BRIEF DESCRIPTION OF THE DRAWINGS

FIG. 1 is a schematic diagram of a door lock in the related art;

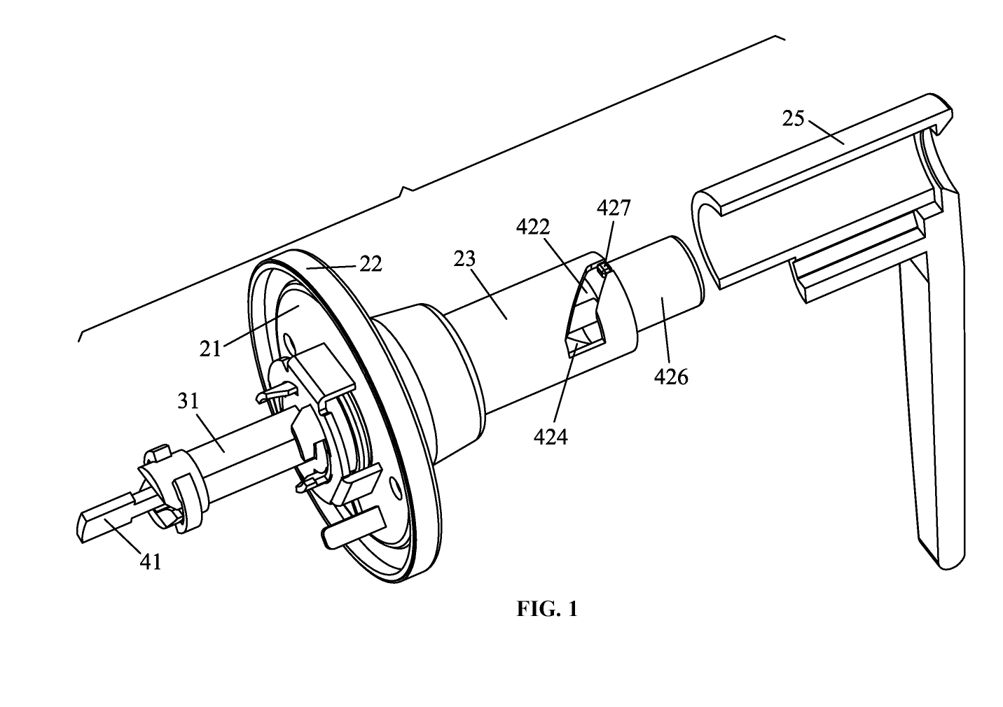

FIG. 2 is a first exploded view of a door lock as described in the disclosure;

FIG. 3 is a second exploded view of a door lock as described in the disclosure; and

FIG. 4 is a third exploded view of a door lock as described in the disclosure.

### DETAILED DESCRIPTION

To further illustrate, embodiments detailing a door lock are described below. It should be noted that the following embodiments are intended to describe and not to limit the disclosure.

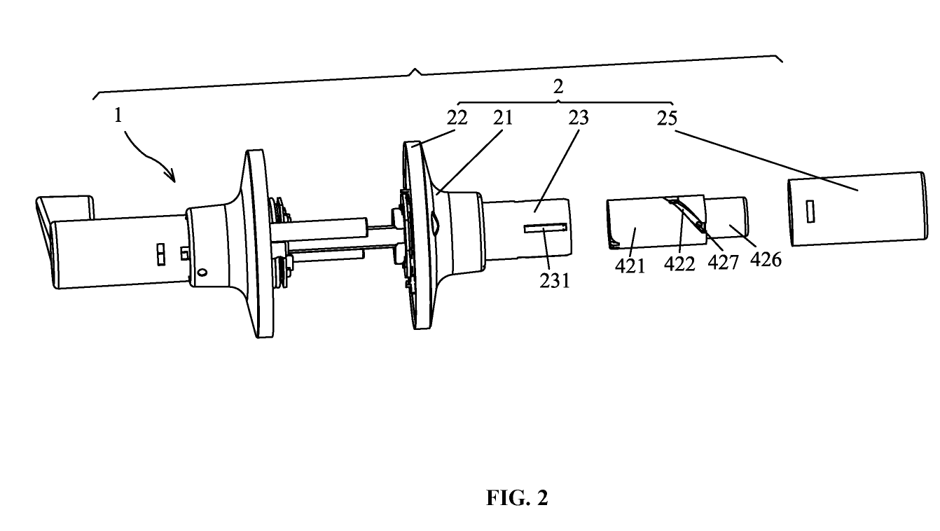

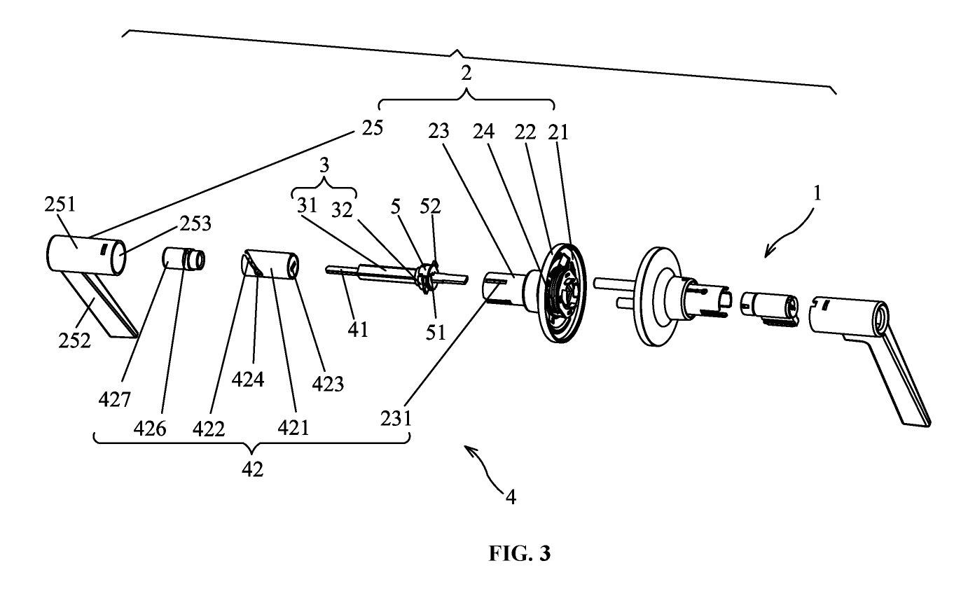

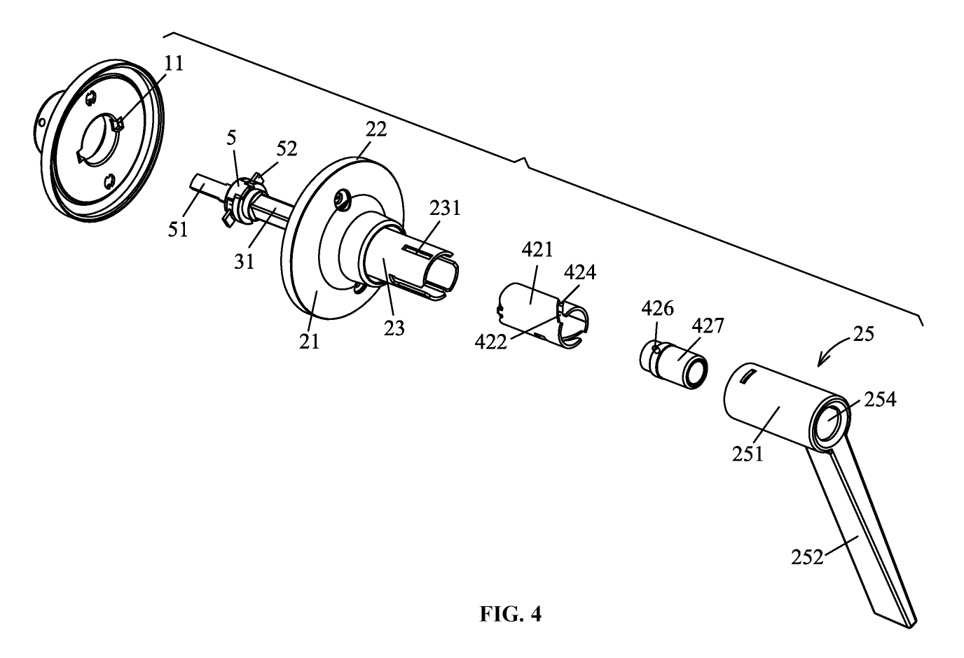

As shown in FIGS. 2-4, provided is a door lock comprising an outer handle assembly 1; an inner handle assembly 2; a clutch 3 disposed between the outer handle assembly 1 and the inner handle assembly 2; and a safety mechanism 4 disposed on the clutch 3. The inner handle assembly 2 comprises an inner baffle 21, an inner shielding cover 22, a hollow cylindrical passage 23, a transmission rack 24, and an inner handle 25. The clutch 3 comprises a transmission square tube 31 and a sub-clutch part 32 connected to the transmission square tube 31. The safety mechanism 4 comprises a brake bar 41 and a driving unit 42 which are disposed in the transmission square tube 31. The hollow cylindrical passage 23 comprises a side wall and a plurality of axial guide grooves 231 disposed on the side wall. The driving unit 42 comprises a sleeve tube 421 and an actuator 427 disposed in the sleeve tube; a tube wall of the sleeve tube is provided with an inclined chute 422 deviating from an axial direction of the sleeve tube; one end of the sleeve tube 421 is provided with a tube hole 423 corresponding to the brake bar 41; one terminal end of the inclined chute 422 is provided with a locating slot 424. The actuator 427 comprises a sliding positioning tongue 426 disposed on a circumferential surface of the actuator to drag the actuator 427 to slide along the plurality of axial guide grooves 231 and push the sleeve tube 421 to rotate and be clamped in the locating slot 424 of the inclined chute 422.

The inner baffle 21 is embedded in the inner shielding cover 22; the hollow cylindrical passage 23 is in running fit with the inner baffle 21 and the inner shielding cover 22; and the transmission rack 24 is disposed at one side of the hollow cylindrical passage 23, and the inner handle 25 is disposed at the other side of the hollow cylindrical passage 23.

The door lock further comprises a lock piece 5 disposed between the sub-clutch part 32 and the outer handle assembly 1; the lock piece 5 comprises a through hole 51 and a lug 52, and the brake bar 41 is inserted in the through hole 51 of the lock piece 5; the outer handle assembly 1 comprises a locking groove 11 corresponding to the lug 52.

The inner handle 25 comprises a base 251 and a hand grip 252; one end of the base 251 is provided with a connection hole 253, and the other end of the base 251 is provided with a guide hole 254; the hollow cylindrical passage 23 is inserted into the connection hole 253 of the base 251, and the lock piece 5 is in sliding fit with the guide hole 254 of the base 251.

The working principle of the door lock is summarized as follows: when the actuator 427 is pressed by a user, the sliding positioning tongue 426 tends to slide longitudinally under the action of the axial guide grooves 231 of the hollow cylindrical passage 23; under the drive of the sliding positioning tongue 426, the sleeve tube 421 rotates in the hollow cylindrical passage 23 along the inclined chute 422 until the sliding positioning tongue 426 is clamped in the locating slot 424; meanwhile, during the rotation of the sleeve tube 421, the brake bar 41 inserting in the tube hole 423 of the sleeve tube 421 also rotates, and when the actuator 427 is pressed, the sleeve tube 421 pushes the brake bar 41 to move longitudinally; when the sliding positioning tongue 426 is clamped in the locating slot 424, the lug 52 of the lock piece 5 is clamped in the locking groove 11 of the outer handle assembly 1, achieving the locking. In the locking process, the actuator 427 does not rotate, thus simplifying the locking process and improving the security of the door lock.

To unlock the door lock, turn the inner handle 25 clockwise or counterclockwise, then the sliding positioning tongue 426 detaches from the locating slot 424 and slide in the inclined chute 422 to reset the actuator 427; meanwhile, the lug 52 of the lock piece 5 detaches from the locking groove 11 of the outer handle assembly 1, achieving the unlocking. In this embodiment, the sliding positioning tongue 426 is easy to detach from the locating slot 424 and slide in the inclined chute 422 to achieve the unlock the process, preventing the jamming of the sliding positioning tongue 426 in the locating slot 424.

It will be obvious to those skilled in the art that changes and modifications may be made, and therefore, the aim in the appended claims is to cover all such changes and modifications.

What is claimed is:

1. A door lock, comprising:
an outer handle assembly;
an inner handle assembly;
a clutch disposed between the outer handle assembly and the inner handle assembly; and
a safety mechanism disposed on the clutch;
wherein:
the inner handle assembly comprises an inner baffle, an inner shielding cover, a hollow cylindrical passage, a transmission rack, and an inner handle;
the clutch comprises a transmission square tube and a sub-clutch part connected to the transmission square tube;
the safety mechanism comprises a brake bar and a driving unit which are disposed in the transmission square tube;
the hollow cylindrical passage comprises a side wall and a plurality of axial guide grooves disposed on the side wall;
the driving unit comprises a sleeve tube and an actuator disposed in the sleeve tube; a tube wall of the sleeve tube is provided with an inclined chute deviating from an axial direction of the sleeve tube; one end of the sleeve tube is provided with a tube hole corresponding to the brake bar; one terminal end of the inclined chute is provided with a locating slot; and
the actuator comprises a sliding positioning tongue disposed on a circumferential surface of the actuator to drag the actuator to slide along the plurality of axial guide grooves and push the sleeve tube to rotate and be clamped in the locating slot of the inclined chute.

2. The door lock of claim 1, further comprising a lock piece disposed between the sub-clutch part and the outer handle assembly; wherein the lock piece comprises a through hole and a lug, and the brake bar is inserted in the through hole of the lock piece; the outer handle assembly comprises a locking groove corresponding to the lug.

3. The door lock of claim 1, wherein:
the inner baffle is embedded in the inner shielding cover;
the hollow cylindrical passage is in running fit with the inner baffle and the inner shielding cover; and
the transmission rack is disposed at one side of the hollow cylindrical passage, and the inner handle is disposed at the other side of the hollow cylindrical passage.

4. The door lock of claim 1, wherein the inner handle comprises a base and a hand grip; one end of the base is provided with a connection hole, and the other end of the base is provided with a guide hole; the hollow cylindrical passage is inserted into the connection hole of the base, and the lock piece is in sliding fit with the guide hole of the base.
